(19) United States
(12) Patent Application Publication
(10) Pub. No.: US 2015/0346713 A1
(43) Pub. Date: Dec. 3, 2015

(54) Method for Processing an Automation Project Using a Plurality of Processing Stations

(71) Applicant: Siemens Aktiengesellschaft, Muenchen (DE)

(72) Inventors: Serge Gerber, Aurachtal (FR); Fabio Perna, Nurnberg (DE); Georg Rupprecht, Nurnberg (DE)

(73) Assignee: Siemens Aktiengesellschaft, Muenchen (DE)

(21) Appl. No.: 14/294,614

(22) Filed: Jun. 3, 2014

(51) Int. Cl. G05B 19/418

(52) U.S. Cl. CPC G05B 19/418; G05B 2219/50233

(57) ABSTRACT

A method for processing an automation project having at least one object using a plurality of processing stations includes storing the automation project on an industrial automation component. The method also includes storing a copy of the automation project on each of the plurality of processing stations, respectively. Each of the copy of the automation project includes a copy of the at least one object for processing. The method further includes storing the time of the last change as a change time with or in each of the at least one object and its copies. The method also includes bringing a copy of the at least one object stored in a processing station into line with the at least one object stored in the automation component when synchronizing a copy of the automation project stored in the processing station with the automation project of the automation component.

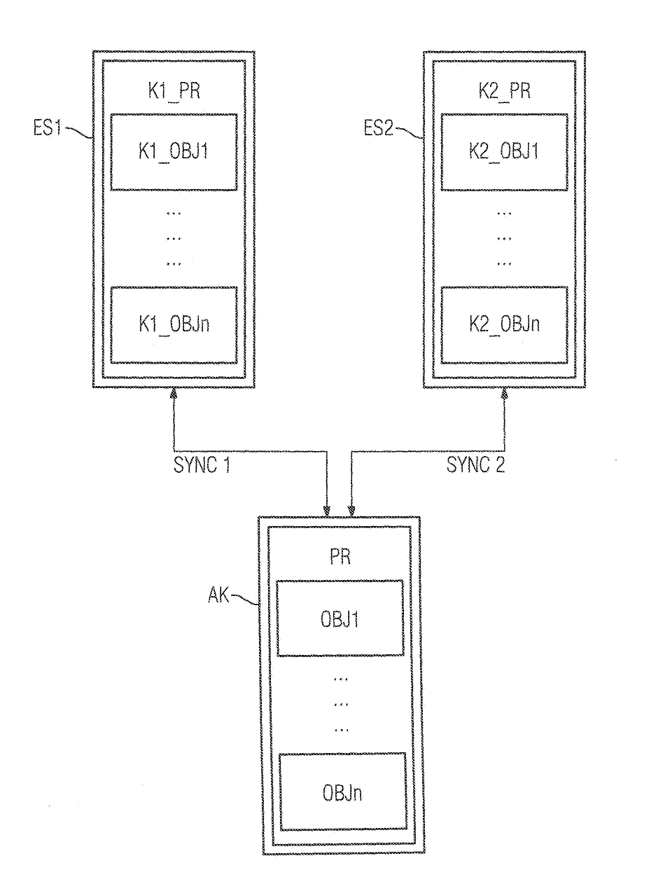

### FIELD OF INVENTION

The invention relates to a method for processing an automation project having at least one object using a plurality of processing stations and to a processing station for carrying out the method.

### DESCRIPTION OF THE RELATED ART

Industrial automation components for use in industrial automation arrangements, in particular in production automation or process automation, substantially obtain their functionality by installing corresponding software. The software usually includes a multiplicity of functions, software modules, data modules, blocks or the like; all of these parts of the software projects or automation projects shall be referred to as objects below.

In particular, during the start-up phase of an automation arrangement and therefore also of an automation component, such as programmable logic controller (PLC), a plurality of persons or companies often work on the same control system and therefore on the same automation project at the same time or in a parallel manner. In modern systems, the automation project which is being processed is already stored in this case on the industrial automation component, in which case, in contrast to older systems, the source code of the objects, in particular program or software modules, is likewise also stored on the automation components and can be retrieved therefrom. However, the problem described below and the proposed solution can also be applied to program memories or similar servers which are not themselves a control device or the like of an automation arrangement and can therefore also be considered to be an automation component in the sense of the problem described here.

In order to process the automation project and therefore the objects contained therein in a parallel manner, each person uses his own programming device which shall also be referred to as an “engineering system” below. Such an engineering system includes, e.g., at least one editor for processing program code (source code), a compiler for translating program code into executable code, a linker for merging different compiled program modules to form a complete program, etc. The process during which an executable project is created from the different program modules in the form of source code is also referred to as “build”; during a “build,” the consistency of an automation project is also checked, that is to say the interaction of the different program modules is ensured.

In order to process the automation project at different processing stations, that is to say engineering systems, each person or start-up engineer has usually stored a copy (“project copy”) on his engineering system, in which case the automation project stored as a copy is synchronized, that is to say brought into line, with the automation component (“target”) or the “original” of the automation project stored there from time to time. Some or all of the objects contained in the automation project are regularly synchronized using this synchronization.

During the parallel processing of an automation project at a plurality of processing stations (engineering systems), the problem often arises that only the program parts (objects), which have been processed by the processor and for which the processor has assumed responsibility, are necessarily up-to-date locally for each processor on his programming device or processing station. It is, therefore, naturally strictly necessary to avoid those program parts, for which other start-up engineers or persons have assumed responsibility and have therefore been processed or changed in the meantime, being overwritten or influenced during synchronization with the automation component. This regularly requires agreements between the persons involved but cannot prevent the unintentional overwriting of changes by other persons. Such unintentional access operations may result in dangerous inconsistencies on the automation component which may result in malfunctions or the like.

In order to avoid such inconsistent states of the productive automation project stored on the automation component, modern control systems often have so-called “system-controlled consistency protection,” wherein it is ensured that all objects of the automation project match the synchronizing processing station after a synchronization process, i.e., during synchronization, all of those objects whose release of the version on the automation component differs from the version in the copy of this synchronizing processing station are synchronized. It is thus assumed that the copy of the automation project which has been stored and possibly changed on the synchronizing processing station has been checked for its “internal” consistency before the synchronization step, for example by carrying out a “build.” However, the described procedure does not prevent interim changes being unintentionally overwritten by other processing stations—on the contrary, it is still the operator's responsibility to detect interim changes by other processing stations and to protect them from being overwritten.

### SUMMARY OF THE INVENTION

One object of the present invention is therefore to improve the parallel processing of automation projects on a plurality of processing stations and, in particular, to avoid the unintentional overwriting of changes to objects in the process.

A central concept of the achievement of this object according to the invention is that a so-called “download identifier,” such as a time stamp (also referred to as a “download time stamp”), is introduced. The download identifier logs, for each copy (working copy) of an object of each processing station, the time at which this object was last transmitted (“download”) to the automation component and possibly replaced an existing, older version of the object there. Therefore, each successful “download” actually results in a new, valid “version” of the object. The important factor in this case is that editing, compiling or other processing of the copy of the object on the processing station does not change this “download time stamp”, which is locally associated with the copy, as long as the changed object has not been transmitted to the automation component.

According to the invention, during synchronization, it is always possible to determine in this case whether a relevant object which is already on the automation component has been changed since the last “download” of the relevant object carried out by the now synchronizing processing station. In this case, use is made of the fact that, in the prior art, provision is already made for the time of the last change to be logged as a “change time stamp” for each object when an object is changed (for example edited), wherein this time stamp is usually stored together with the object. Whereas a comparison of the “download time stamp” of the object stored on the automation component with the “download time stamp” of the copy of this object on the synchronizing processing station during a synchronization process therefore provides information on whether the relevant object has been changed by another processing station since the last synchronization of this processing station and has therefore been stored on the automation component, examination of the change time stamps and of the download time stamps according to the invention can be used to decide on the further procedure for ensuring consistency.

The object is achieved, in particular, by the method and processing station of the claimed invention. In one embodiment, a method for processing an automation project having at least one object, in particular a software module, using a plurality of processing stations includes storing the automation project on an industrial automation component, and storing a copy of the automation project respectively on the processing stations with a copy of the at least one object for processing. The method also includes storing the time of the respective last change respectively as the change time with or in the object and its copies, and, when synchronizing a copy of an automation project of a processing station with the automation project of the automation component, bringing the copy of the object of this synchronizing processing station into line with the corresponding object of the automation component.

In this case, the time of each successful synchronization of the object is stored both as an offline download time stamp of the synchronized copy and as an online download time stamp in a manner associated with the object stored on the automation component therewith, and in that case, before synchronizing one of the copies of the object, the offline download time stamp of the object to be synchronized is compared with the online download time stamp of the object on the automation component in a first step. In the event of a match between offline download time stamp and the online download time stamp, the object is transmitted from the processing station to the automation component and is stored there. Otherwise, the offline download time stamp of the copy of the object is compared with the stored change time of this copy in a second step, and, if this change time is older than this download time stamp, the object is transmitted from the automation component to the processing station and there replaces the copy of the object. Otherwise, the object is transmitted from the automation component to the processing station and is compared and/or combined there with the copy of the object in a third step. This method ensures that interim changes to an object by another processing station are determined, on the one hand, and are taken into account, on the other hand, in the copy of the automation project of the currently synchronizing processing station, wherein, in cases in which both the currently synchronizing processing station and another processing station have made changes to the object, this can also be detected and taken into account.

The object is also achieved using a processing station for an automation project having at least one object that is stored on an industrial automation component. The processing station is set up to carry out the method described above. Such a processing station makes it possible to achieve the advantages described above.

The claimed invention also includes advantageous refinements of the method according to the invention. The features and advantages described in this case analogously also apply to the processing station according to the invention. The advantageous variants described in the claimed invention can be used both individually and in combination with one another.

In the event of a match between the download time stamps of the object to be synchronized and the online download time stamp of the object already present on the automation component, the object is advantageously not transmitted to the automation component in the first step of the method, with the result that an unnecessary transmission and storage process can be omitted and time and transmission resources can therefore be saved.

In one advantageous refinement, the object is present on the automation component both as source code and as an executable object (“object code”), in which case at least the source code of the object is transmitted in the first, second and third steps. This dispenses with the other need to keep the source code of the executable objects in a separate source code database. Furthermore, use is made here of the fact that only the source code is needed to process the automation project, in which case the object code can be generated again anyway during a “build” using compiling processes.

If the change time is older than the download time stamp, the automation project changed on account of the copy transmitted from the automation component is advantageously compiled and/or its consistency is checked in the second step, for example by carrying out a “build.” This ensures that the object “uploaded” by the automation component and its changes do not result in inconsistencies in the copy of the automation project of the currently synchronizing processing station. After this “build” or other measures for ensuring the consistency of the copy of the automation project, the synchronization can be continued or restarted, as a result of which the then consistent state of the copy of the automation project has been transmitted to the automation component at the latest when all objects have been examined using the method according to the invention.

### BRIEF DESCRIPTION OF THE DRAWINGS

One exemplary embodiment of the method according to the invention is explained below using the drawings. The exemplary embodiment is simultaneously used to explain a processing station according to the invention.

In this case, the single FIGURE schematically shows an automation project of an automation component and the copies of the automation project on two processing stations in accordance with one embodiment of the present invention.

### DETAILED DESCRIPTION OF THE PRESENTLY PREFERRED EMBODIMENTS

The FIGURE shows a simplified schematic illustration of the program memory of an automation component AK containing an automation project PR, this automation project PR comprising a number of objects OBJ1, . . . , OBJn. Copies K1_PR, K2_PR of the automation project PR are stored on the processing stations ES1, ES2 (“engineering systems”); these copies of the automation project K1_PR, K2_PR each also comprises copies of the objects K1_OBJ1, . . . K1_OBJn and K2_OBJ1, . . . K2_OBJn. It is assumed that each of the processing stations ES1, ES2 is operated independently of the other in each case by a software engineer who can process the corresponding copies of the objects K1_OBJ1, . . . K2_OBJn and from time to time synchronizes the automation project K1_PR, K2_PR, which is respectively locally present as a copy, with the automation project PR of the automation component AK, i.e., brings them into line, using synchronization processes SYNC1, SYNC2. Such a synchronization process SYNC1 shall be explained below.

The object OBJ1 shall be considered below by way of example, in which case synchronization SYNC1 of the processing station ES1 with the automation component AK is also described by way of example, and in which case this synchronization SYNC1 takes place object by object, beginning with the object OBJ1. In this case, it is assumed that, with each substantial change of an object OBJ1 or a copy of the object K1_OBJ1, K2_OBJ1, the time of this substantial change is respectively recorded as a change time stamp. Even though these change time stamps of the object OBJ1 or of the copies of the object K1_OBJ1, K2_OBJ1 can also be stored in an external database or the like, it is assumed in the present exemplary embodiment that these change time stamps and the subsequently discussed download time stamps are stored with, the respective object or its copy, for example using an entry in a file system.

In this case, the change time may be, for example, that time at which the corresponding object OBJ1 or its copy K1_OBJ1, K2_OBJ1 was last compiled. That is to say the time stamp need not necessarily be associated with the source code of the object but can also relate to the executable code produced (object code, machine code or the like). However, for the sake of simplicity, it is assumed below that the time stamps always relate to the source code and the change time stamps for the respective source code both of the object OBJ1 stored on the automation component AK and for the copies stored on the processing stations ES1, ES2 each indicates the time at which the corresponding source code file was actually last changed, for example by virtue of an included function or the like being processed.

Furthermore, for each object, to be precise both for the “productively” stored “original” of the object OBJ1 and for the “working copies” of the object K1_OBJ1, K2_OBJ1, it is respectively recorded when this object or its copy was last transmitted to the automation component AK and stored there. This means that this “download time stamp” is identical both for the object OBJ1 and for the copy K1_OBJ1 if that version of the object OBJ1 which is present on the automation component AK comes from the processing station ES1. In cases in which the processing station ES2 last transmitted the copy of the object K2_OBJ1 to the automation component AK and stored it there for example, precisely the “download time stamp” of the object OBJ1 is identical to that of the copy of the object K2_OBJ1.

Since file systems store the time of the last storage of an object or a file anyway in many cases, this file system entry from the file system of the automation component AK can be used as an “online download time stamp” of the object OBJ1; this naturally does not go for the copies of this object K1_OBJ1, K2_OBJ1 because it is irrelevant when the copies were each stored; this information does not state anything about when this object was last transmitted to the automation component AK.

During synchronization SYNC1 of the processing station ES1 with the automation component AK, a check is first carried out, for each object and therefore also for the object OBJ1 or the local copy of this object K1_OBJ1, in order to determine whether synchronization and therefore a “download” is actually necessary. In this case, the change time of the “online object” OBJ1 is retrieved from the automation component AK and is compared with the (last) change time of the copy of the object K1_OBJ1; if these two change times match, it is assumed that the copy of the object K1_OBJ1 matches the object OBJ1 and synchronization of this object is therefore not required.

It is assumed below that the change times differ. This means that the locally stored copy of the object K1_OBJ1 is most likely not identical to the “online object” OBJ1. The question therefore arises of who or which processing station ES1, ES2 has caused this difference, and from that determination emerge the measures to be subsequently carried out.

For this purpose, the “online download time stamp” of the object OBJ1 from the automation component AK is now compared with the “offline download time stamp” of the copy of the object K1_OBJ1. This comparison is practically carried out by the processing station ES1 which also controls the synchronization process SYNC1. For this purpose, the “online download time stamp” of the object OBJ1 is retrieved from the automation component AK. If these two “download time stamps” are the same, it can be assumed that the currently synchronizing processing station ES1 last transmitted the object. OBJ1 to the automation component AK and stored it there, albeit in a different processing state. The difference in the change time stamps must therefore stem from the fact that the processing station ES1 or its user has changed the copy of the object K1_OBJ1 since the last separate “download” of the object OBJ1, while the processing station ES2 could not make any changes to the object OBJ1 in the meantime. In this case, the copy of the object K1_OBJ1 may be provided for the “download” to the automation component AK, in which case this “download” should be effected only when all objects OBJ1, . . . OBJn have been accordingly examined.

The different case shall now be discussed, that is to say when the two previously compared “download time stamps” differ from one another. This means that, since the last synchronization of the processing station ES1 with the automation component AK, the object OBJ1 stored there has been stored or “overwritten” in the meantime by another processing station, for example by the processing station ES2. In a real production environment, far more processing stations may naturally also work on the automation project.

In the present case now, simple overwriting of the object OBJ1 of the automation component AK with the local copy K1_OBJ1 would possibly result in inconsistent states or else at least in destruction of the changes to the object OBJ1 which have been made in the meantime. The goal is therefore to distinguish between whether or not only another processing station, for example the processing station ES2, has changed the object OBJ1 since the last synchronization of the processing station ES1 with the automation component AK, or whether or not the copy of the object OBJ1 has also been changed in the processing station ES1 since the last successful “download”.

If the “offline” change time stamp of the copy of the object K1_OBJ1 is older than the (separate) “offline download time stamp” of the copy of the object K1_OBJ1, the object or the copy of the object K1_OBJ1 has not been changed since the last synchronization of the processing station ES1 in this processing station ES1. It means that only another processing station has therefore changed the object OBJ1. In this case, the object OBJ1 can be “uploaded” by the automation component to the processing station ES1 and can replace or overwrite the previous copy of the object K1_OBJ1 there. The changes by another processing station have therefore been included in the copy of the automation project K1_PR. It must now be ensured that no inconsistent state has been produced on account of the other changes, and inconsistencies which have been produced must be rectified.

For this purpose, the consistency of the copy of the automation project K1_PR is checked by compiling the automation project or the copy of the automation project K1_PR, for example using a “build,” in which case any inconsistencies become apparent and can therefore be rectified. The synchronization SYNC1 can then be continued or restarted, in which case the object OBJ1 of the automation component AK and its copy K1_OBJ1 must now inevitably be identical and any differences with respect to the other objects must be determined and rectified, if necessary.

Unlike in the case described last in which only another processing station has made changes to the object OBJ1, the situation may occur in which the change time stamp is younger than the “download time stamp” when comparing the “offline” change time stamp of the copy of the object K1_OBJ1 with the “offline download time stamp” of the copy of the object K1_OBJ1. In this case, the copy of the object K1_OBJ1 was also changed in the processing station ES1 since the last synchronization. Together with the previous knowledge that another processing station has also changed the object OBJ1 in the meantime, resulting from the comparison of the “download time stamps”, the situation has therefore occurred in which competing changes have been made to the object OBJ1, i.e., both by the processing station ES1 and by another processing station.

In such a situation as well, the object OBJ1 should first be “uploaded” by the automation component to the processing station ES1 but must not overwrite the existing copy of the object K1_OBJ1 there for the time being. Rather, the uploaded object OBJ1 and the copy of the object K1_OBJ1 which is already present must be combined, for which purpose it may be useful, for example, to compare the two objects with one another using a text comparison or the like, with the result that an operator can detect contradictory changes and can consolidate the two versions available to him to form a single version.

After this consolidation, it is recommended to ensure, for example using a “build,” that the resulting version is consistent with the remaining copies of the objects inside the copy of the automation project K1_PR. The synchronization process SYNC1 can then be continued or restarted, but, in the event of a restart, the consistency check for the object OBJ1 should be skipped and the “consolidated” version of the object OBJ1 should instead be transmitted to the automation component AK and stored there.

In summary, the sequences described above ensure that, in cases in which all changes to the software of an automation component are always made from the same project copy, the system-controlled consistency protection known from the prior art for obtaining a consistent state on the automation component AK suffices. If objects are loaded onto the automation component from changing project copies K1_PR, K2_PR, the newly introduced “download time stamps” (also referred to as “download identifiers”) and a synchronization function based thereon can be used to ensure that consistency of the project PR can nevertheless be ensured even in the case of independent expansions or changes in objects.

This applies even to the case in which a change to be adopted has repercussions on other parts of the project, for example as a result of addresses being recompiled or the like. In the case of dependent expansions, for example, as a result of simultaneous changes by a plurality of processing stations ES1, ES2, this is at least detected, and inconsistencies can be avoided solely as a result of the detection and a corresponding reaction, in particular by using comparison editors and other known aids.

The series of detailed descriptions set forth above are only specific descriptions directed to the feasible embodiments of the present invention, and are not intended to limit the scope of protection of the present invention; and all the equivalent embodiments or modifications made without departing from the technical spirit of the present invention shall be included in the scope of protection of the present invention.

What is claimed is:

1. A method for processing an automation project having at least one object using a plurality of processing stations, the method comprising:
storing the automation project on an industrial automation component;
storing a copy of the automation project on each of the plurality of processing stations, respectively, wherein each of the copy of the automation project includes a copy of the at least one object for processing,
storing the time of the last change as a change time with or in each of the at least one object and its copies, and
bringing a copy of the at least one object stored in a processing station into line with the at least one object stored in the automation component when synchronizing a copy of the automation project stored in the processing station with the automation project of the automation, component,
wherein the time of each successful synchronization of the at least one object is stored both as an offline download time stamp of the synchronized copy and as an online download time stamp in the at least one object stored on the automation component therewith,
wherein, before synchronizing one of the copies of the at least one object, the offline download time stamp of the at least one object to be synchronized is compared with the online download time stamp of the at least one object on the automation component in a first step,
wherein, in the event of a match in the first step, the at least one object is transmitted from the corresponding processing station to the automation component and is stored there, and
wherein, in the event of a non-match in the first step, the offline download time stamp of the copy of the at least one object is compared with the stored change time of this copy in a second step, in which case, if this change time is older than this download time stamp, the at least one object is transmitted from the automation component to the processing station and there replaces the copy of the at least one object, and otherwise the at least one object is transmitted from the automation component to the processing station and is compared and/or combined there with the copy of the at least one object in a third step.

2. The method of claim 1, wherein, in the event of a match, the at least one object is not transmitted to the automation component in the first step.

3. The method of claim 1, wherein the at least one object is present on the automation component both as source code and as an executable object, and wherein at least the source code of the object is transmitted in the first, second and third steps.

4. The method of claim 1, wherein, if the change time is older than the download time stamp, the automation project changed using the copy transmitted from the automation component is compiled and/or its consistency is checked in the second step, after which the automation project of the processing station is synchronized again with the automation project of the automation component.

5. A processing station for an automation project having at least one object, the processing station comprising a copy of an automation project being stored on an industrial automation component, wherein the processing station is set up to carry out the method of claim 1.
